(19) United States
(12) Patent Application Publication
(10) Pub. No.: US 2020/0282537 A1
(43) Pub. Date: Sep. 10, 2020

(54) ELECTRIC STAPLER

(71) Applicant: Eagle (Shaoguan) Stationery Technology Limited, Shaoguan (CN)

(72) Inventors: Siu Leung CHAN, Shaoguan (CN); Huixiong XIONG, Shaoguan (CN); Guantai CHEN, Shaoguan (CN)

(21) Appl. No.: 16/410,118

(22) Filed: May 13, 2019

(30) Foreign Application Priority Data
Mar. 4, 2019 (CN) 201910159335.0

(51) Int. Cl. B25C 7/00; B25C 5/15

(52) U.S. Cl. CPC B25C 7/00; B25C 5/15

(57) ABSTRACT

The present invention relates generally to the technical field of office stationery. More particularly, it relates to an electric stapler comprising a left cover and a right cover, wherein an accommodation space is formed when said left and right covers buckle together. Inside the accommodation space, there disposes a driving mechanism, a pressing mechanism, a control mechanism, a binding mechanism, a circuit board and a distance adjusting block, wherein said driving mechanism is connected to said pressing mechanism through a transmission shaft for driving the pressing mechanism to move up and down; said binding mechanism is disposed under the driving mechanism and the pressing mechanism, said distance adjusting block is disposed on the binding mechanism in front of the staple outlet, and the paper feeding switch in sais control mechanism is disposed on the distance adjusting block. The present invention can change the distance from the staple outlet to the paper feeding switch with the distance adjusting block, thereby adjusting the binding distance of the paper edge to meet different requirements on binding margin

### TECHNICAL FIELD

The present invention relates generally to the technical field of office stationery. More particularly, it relates to an electric stapler.

### STATE OF THE PRIOR ART

The staplers commonly used on the market generally require manual paper-punching, which are not convenient in use. Therefore, in order to eliminate the inconvenience of manual stapler in use, electric stapler is introduced to the market. The current electric staplers do not allow the adjustment of the binding distance of the paper edge while the existing electric staplers are mostly of the complicated spur gear structure, which generates much noise and are instable in functioning.

### SUMMARY OF THE INVENTION

It is an object the present invention is to provide an electric stapler as a solution to the deficiencies in the prior art, which adjusts the binding distance of the paper edge with a distance adjusting block and adopts planetary gear and sliding stapling structures, enabling the electric stapler to enjoy large transmission torque, stable functioning, steady stapling, low noise, and good strength.

In order to accomplish this, the invention comprises the following solutions:

An electric stapler, comprising a left cover and a right cover, wherein an accommodation space is formed when said left and right covers buckle together, and it further comprises:

A binding mechanism, wherein said binding mechanism comprises a base and a binding frame and the back ends of the base and the binding frame are rotatably connected by a pivot;

A pressing mechanism, wherein said pressing mechanism is disposed above the front end of the binding frame for driving the binding mechanism to complete the binding;

A driving mechanism, wherein said driving mechanism is disposed above the binding mechanism, said driving mechanism is connected to said pressing mechanism through a transmission shaft, and said driving mechanism is used to drive the pressing mechanism to move up and down;

A distance adjusting block, wherein said distance adjusting block is of a U-shaped structure, comprising an integrally-formed left shell, right shell and front plate, wherein said left shell and right shell are respectively snapped into the left and right side walls of the base, and the distance adjusting block is able to slide relative to the side wall of the base;

A control mechanism, wherein said control mechanism comprises a paper feeding switch and a pressing switch, with pressing switch disposed at the buckling portion of the back ends of the left cover and the right cover, and said paper feeding switch disposed on the front plate of the distance adjustment block;

A circuit board, wherein said driving mechanism and the control mechanism are electrically connected to the circuit board; and

Said binding mechanism, pressing mechanism, driving mechanism, distance adjusting block, control mechanism and circuit board are all disposed in the accommodation space.

Further, said driving mechanism comprises a motor and a gear box disposed in front of the motor, wherein said gear box comprises an internal gear and an internal gear cover, said internal gear in driving connection to the motor. In said gear box, there disposes a first planetary gear set, a first sun gear, a second planetary gear set, a second sun gear, a third planetary gear set and two planet carriers, wherein said first sun gear are integrally formed with one planet carrier and said first planetary gear set is disposed on the other side of the planet carrier, while the second planetary gear set is integrally formed with the other planet carrier and the second sun gear is disposed on the other side of the other planet carrier. The third planetary gear set is disposed on the internal gear cover. Said first planetary gear set meshes with the internal gear, the second planetary gear set meshes with the internal gear and the first sun gear respectively, and the third planetary gear set meshes with the internal gear and the second sun gear respectively.

Preferably, said gear box further comprises a spacer inside, wherein said spacer is disposed at the front end of the first planetary gear set.

Preferably, the numbers of planetary gears in said first planetary gear set, second planetary gear set and third planetary gear set are all three.

Further, a bracket supporting the driving mechanism and the pressing mechanism is comprised, wherein the bracket is connected to said binding mechanism.

Preferably, the bracket comprises a stop switch, wherein when said binding mechanism completes one binding, said pressing mechanism touches said stop switch, thus activating the stop switch.

Further, said pressing mechanism comprises a sliding frame, a cam disposed inside the sliding frame, and a pressing piece disposed at the bottom of the sliding frame, wherein said cam is sleeved on the transmission shaft.

Preferably, said sliding frame comprises a hard rubber block and a damping rubber inside, wherein said damping rubber is disposed under the hard rubber block, and said hard rubber block is disposed under the cam.

Further, said binding frame comprises a core groove, a core for accommodating staples, a thruster for conveying staples, a spring for driving the thruster to slide, a hook, a buffer block, and a hook spring, wherein said core is disposed in the core groove, said buffer block is disposed at the back end of the core, said hook is fixed at the back end of the core groove, and said spring is connected to the back end of the core groove at one end while the other end of the spring is connected to the thruster bypassing the front end of the core groove. After the back ends of said base and said binding frame are connected by the pivot, the hook spring is sleeved on the pivot to abut the hook.

Further, said base comprises a battery rack at the back end for accommodating the batteries and a battery cover at the bottom of said base, wherein the upper end of the battery rack is provided with a protection switch. When said core is closed, the protection switch is in contact with the buffer block and the protection switch is on. When the core is opened, the protection switch is separated from the buffer block and the protection switch is off.

Compared with the prior art, the present invention has the following beneficial effects:

1. The electric stapler of the present invention comprises a driving mechanism, a pressing mechanism, a binding mechanism and a control mechanism. In addition, it also comprises a distance adjusting block, which can change the distance from the staple outlet to the paper feeding switch, thereby adjusting the binding distance of the paper edge to meet different requirements on binding margin;

2. The electric stapler of the present invention comprises multiple sets of planetary gears, enjoying the advantages of large transmission torque, stable transmission, good strength and low noise;

3. The pressing mechanism in the electric stapler of the present invention comprises a sliding frame and a cam which are driven by the driving mechanism to move up and down, thereby completing the stapling, which is simple in mechanism. Damping rubbers are disposed inside the sliding frame and at the lower part of the cam, which play the buffering and protection role, thus ensuring a stable, reliable and firm stapling.

4. The binding mechanism in electric stapler of the present invention adopts the design of power-off protection by ejecting the core, which, under the effect of the protection switch and the buffer block, avoids personnel injury or damage to the machine caused by accidentally touching the paper feeding switch, thus playing the role of safety protection.

### BRIEF DESCRIPTION OF THE DRAWINGS

FIG. 1 is an exploded view illustrating the structure of the electric stapler of the present invention.

FIG. 2 is a schematic view illustrating the structure of the driving mechanism of the present invention.

FIG. 3 is a schematic view illustrating the assembling of the driving mechanism and the pressing mechanism of the present invention.

FIG. 4 is a schematic view illustrating the assembling of the distance adjusting block and the paper feeding switch of the present invention.

FIG. 5 is a schematic view illustrating the core opening in the binding frame of the present invention.

FIG. 6 is a schematic view illustrating the core closing in the binding frame of the present invention.

### DETAILED DESCRIPTION OF PREFERRED EMBODIMENTS

The invention will be described in details below with reference to the drawings and a specific embodiment.

### Embodiment 1

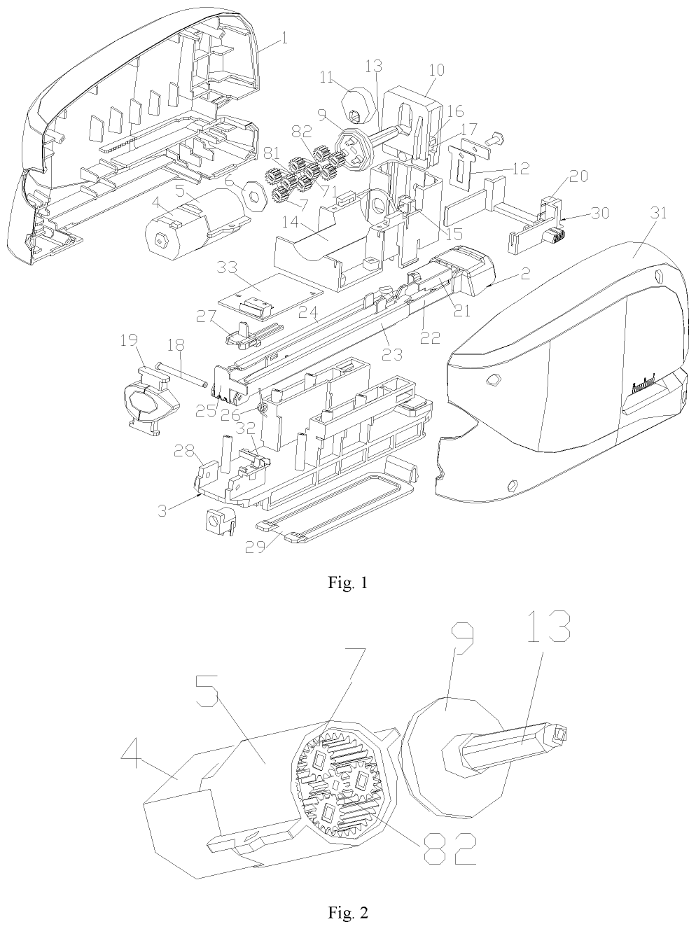

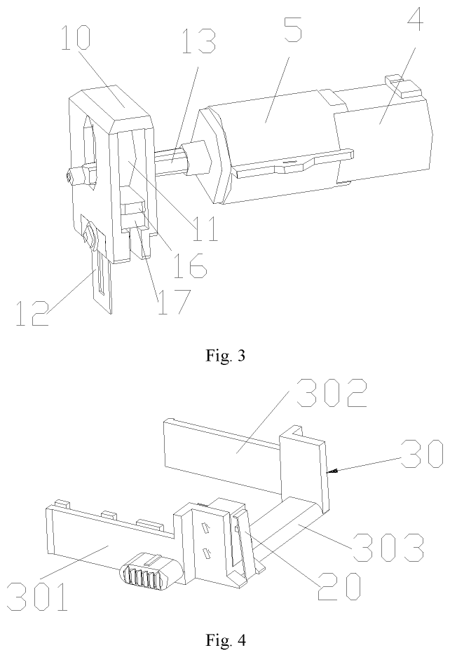

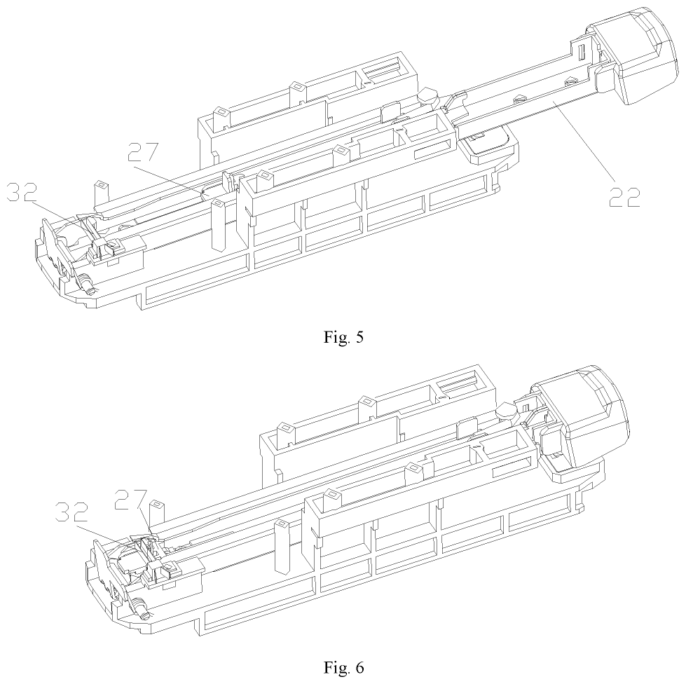

As shown in FIGS. 1 to 6, the embodiment provides an electric stapler, comprising a left cover 1 and a right cover 31, wherein an accommodation space is formed when said left cover 1 and the right cover 31 buckle together, and it further comprises:

A binding mechanism, wherein said binding mechanism comprises a base 3 and a binding frame 2 and the back ends of said base 3 and the binding frame 2 are rotatably connected by a pivot 18;

A pressing mechanism, wherein said pressing mechanism is disposed above the front end of the binding frame 2 for driving the binding mechanism to complete the binding;

A driving mechanism, wherein said driving mechanism is disposed above the binding mechanism, said driving mechanism is connected to said pressing mechanism through a transmission shaft 13, and said driving mechanism is used to drive the pressing mechanism to move up and down;

A distance adjusting block 30, wherein said distance adjusting block 30 is of a U-shaped structure, comprising an integrally-formed left shell 301, right shell 302 and front plate 303, wherein said left shell 301 and right shell 302 are respectively snapped into the left and right side walls of the base 3, and the distance adjusting block 30 is able to slide relative to the side wall of the base 3;

A control mechanism, wherein said control mechanism comprises a paper feeding switch 20 and a pressing switch 19, with pressing switch 19 disposed at the buckling portion of the back ends of the left cover 1 and the right cover 31, and said paper feeding switch 20 disposed on the front plate 303 of the distance adjustment block 30;

A circuit board 33, wherein said driving mechanism and the control mechanism are electrically connected to the circuit board 33; and

Said binding mechanism, pressing mechanism, driving mechanism, distance adjusting block 30, control mechanism and circuit board 33 are all disposed in the accommodation space.

The working principle of the electric stapler of the present invention is as follows: When paper touches the paper feeding switch 20 on the distance adjusting block 30, the circuit is connected. Then the driving mechanism starts to work, driving the pressing mechanism up and down, which drives the binding mechanism to complete the binding. The present invention can change the distance from the staple outlet to the paper feeding switch 20 with the distance adjusting block 30, thereby adjusting the binding distance of the paper edge to meet different requirements on binding margin;

In the embodiment of the present invention, said driving mechanism comprises a motor 4 and a gear box disposed in front of the motor 4, wherein said gear box comprises an internal gear 5 and an internal gear cover 9, said internal gear 5 in driving connection to the motor 4. In said gear box, there disposes a spacer 6, a first planetary gear set, a first sun gear 81, a second planetary gear set, a second sun gear 82, a third planetary gear set and two planet carriers 71. Said first sun gear are integrally formed with one planet carrier 71 and said first planetary gear set is disposed on the other side of the planet carrier 71, while the second sun gear is integrally formed with the other planet carrier 71 and the second planetary gear set is disposed on the other side of the other planet carrier 71. The third planetary gear set is disposed on the internal gear cover 9. Said first planetary gear set meshes with the internal gear 5, the second planetary gear set meshes with the internal gear 5 and the first sun gear 81 respectively, and the third planetary gear set meshes with the internal gear 5 and the second sun gear 82 respectively. The numbers of planetary gears 7 in said first planetary gear set, second planetary gear set and third planetary gear set are all three. The electric stapler of the present invention comprises multiple sets of planetary gears, enjoying the advantages of large transmission torque, stable transmission, good strength and low noise.

In the embodiment of the present invention, a bracket 14 supporting the driving mechanism and the pressing mechanism is comprised, wherein the bracket 14 is connected to said binding mechanism to stabilize the structure, ensuring the steady running of the driving mechanism and the pressing mechanism. Said bracket 14 comprises a stop switch 15, wherein when said binding mechanism completes one binding, said pressing mechanism touches said stop switch 15 and activate the stop switch 15, thereby finishing the binding job and allowing to change the stapling position.

In the embodiment of the present invention, said pressing mechanism comprises a sliding frame 10, a cam 11 disposed inside the sliding frame 10, and a pressing piece 12 disposed at the bottom of the sliding frame 10, wherein said cam 11 is sleeved on the transmission shaft 13. Said sliding frame 10 comprises a hard rubber block 16 and a damping rubber 17 inside, wherein said damping rubber 17 is disposed under the hard rubber block 16, and said hard rubber block 16 is disposed under the cam 11. When the cam 11 rotates 0-180°, the sliding frame 10 is driven to move downward to bind the paper while when the cam 11 rotates 180°-360°, the sliding frame 10 starts to return. When the cam 11 rotates to 360°, the sliding frame 10 returns to the original position and the sliding frame 10 activates the stop switch 15, thus completing the binding. The damping rubber 17 can be compressed to absorb the impact when sheet of paper changes from 1 to 25, playing the buffering and protection role. The pressing mechanism of the present invention makes the whole stapling process stable, reliable, and firm.

In the embodiment of the present invention, said binding frame 2 comprises a core groove 23, a core 22 for accommodating staples, a thruster 21 for conveying staples, a spring 24 for driving the thruster 21 to slide, a hook 25, a buffer block 27, and a hook spring 26, wherein said core 22 is disposed in the core groove 23, said buffer block 27 is disposed at the back end of the core 22, said hook 25 is fixed at the back end of the core groove 23, and said spring 24 is connected to the back end of the core groove 23 at one end while the other end of the spring 24 is connected to the thruster 21 bypassing the front end of the core groove 23. After the back ends of said base 3 and said binding frame 2 are connected by the pivot 18, the hook spring 26 is sleeved on the pivot 18 to the hook 25. Said base 3 comprises a battery rack 28 at the back end for accommodating the batteries and a battery cover 29 at the bottom of said base 3, wherein the upper end of the battery rack 28 is provided with a protection switch 32. When the core 22 is closed, the protection switch 32 is in contact with the buffer block 27 and the protection switch 32 is on. When the core 22 is opened, the protection switch 32 is separated from the buffer block 27 and the protection switch 32 is off. The present invention adopts the design of power-off protection by ejecting the core 22 to avoid personnel injury or damage to the machine caused by accidentally touching the paper feeding switch 20 in the process of staple adding, thus playing the role of safety protection.

It should be understood by those of ordinary skill in the art that the discussion of any of the above embodiments is merely exemplary, and is not intended to suggest that the scope of the disclosure (including the claims) is limited to these examples; Combinations of the technical features in the above embodiments or different embodiments are also possible, and there are many other variations in the various aspects of the present invention as described above, which are not provided in the details for the sake of brevity. Therefore, any omissions, modifications, equivalents, improvements, etc. within the spirit and principle of the present invention are intended to be included in the scope of the present invention.

1. An electric stapler, comprising a left cover and a right cover, wherein an accommodation space is formed when said left and right covers buckle together, and it further comprises:
A binding mechanism, wherein said binding mechanism comprises a base and a binding frame and the back ends of the base and the binding frame are rotatably connected by a pivot;
A pressing mechanism, wherein said pressing mechanism is disposed above the front end of the binding frame for driving the binding mechanism to complete the binding;
A driving mechanism, wherein said driving mechanism is disposed above the binding mechanism, said driving mechanism is connected to said pressing mechanism through a transmission shaft, and said driving mechanism is used to drive the pressing mechanism to move up and down;
A distance adjusting block, wherein said distance adjusting block is of a U-shaped structure, comprising an integrally-formed left shell, right shell and front plate, wherein said left shell and right shell are respectively snapped into the left and right side walls of the base, and the distance adjusting block is able to slide relative to the side wall of the base;
A control mechanism, wherein said control mechanism comprises a paper feeding switch and a pressing switch, with pressing switch disposed at the buckling portion of the back ends of the left cover and the right cover, and said paper feeding switch disposed on the front plate of the distance adjustment block;
A circuit board, wherein said driving mechanism and the control mechanism are electrically connected to the circuit board; and
Said binding mechanism, pressing mechanism, driving mechanism, distance adjusting block, control mechanism and circuit board are all disposed in the accommodation space.

2. The electric stapler according to claim 1, wherein said driving mechanism comprises a motor and a gear box disposed in front of the motor. Said gear box comprises an internal gear and an internal gear cover, said internal gear in driving connection to the motor. In said gear box, there disposes a first planetary gear set, a first sun gear, a second planetary gear set, a second sun gear, a third planetary gear set and two planet carriers, wherein said first sun gear are integrally formed with one planet carrier and said first planetary gear set is disposed on the other side of the planet carrier, while the second planetary gear set is integrally formed with the other planet carrier and the second sun gear is disposed on the other side of the other planet carrier. The third planetary gear set is disposed on the internal gear cover. Said first planetary gear set meshes with the internal gear, the second planetary gear set meshes with the internal gear and the first sun gear respectively, and the third planetary gear set meshes with the internal gear and the second sun gear respectively.

3. The electric stapler according to claim 2, wherein said gear box further comprises a spacer inside. Said spacer is disposed at the front end of the first planetary gear set.

4. The electric stapler according to claim 2, wherein the numbers of planetary gears in said first planetary gear set, second planetary gear set and third planetary gear set are all three.

5. The electric stapler according to claim 1, wherein a bracket supporting the driving mechanism and the pressing mechanism is comprised, wherein said bracket is connected to said binding mechanism.

6. The electric stapler according to claim 5, wherein the bracket comprises a stop switch. When said binding mechanism completes one binding, said pressing mechanism touches said stop switch, thus activating the stop switch.

7. The electric stapler according to claim 1, wherein said pressing mechanism comprises a sliding frame, a cam disposed inside the sliding frame, and a pressing piece disposed at the bottom of the sliding frame, wherein said cam is sleeved on the transmission shaft.

8. The electric stapler according to claim 7, wherein said sliding frame comprises a hard rubber block and a damping rubber inside, wherein said damping rubber is disposed under the hard rubber block, and said hard rubber block is disposed under the cam.

9. The electric stapler according to claim 1, wherein said binding frame comprises a core groove, a core for accommodating staples, a thruster for conveying staples, a spring for driving the thruster to slide, a hook, a buffer block, and a hook spring, wherein said core is disposed in the core groove, said buffer block is disposed at the back end of the core, said hook is fixed at the back end of the core groove, and said spring is connected to the back end of the core groove at one end while the other end of the spring is connected to the thruster bypassing the front end of the core groove. After the back ends of said base and said binding frame are connected by the pivot, the hook spring is sleeved on the pivot to abut the hook.

10. The electric stapler according to claim 9, wherein said base comprises a battery rack at the back end for accommodating the batteries and a battery cover at the bottom of said base, wherein the upper end of the battery rack is provided with a protection switch. When said core is closed, the protection switch is in contact with the buffer block and the protection switch is on. When the core is opened, the protection switch is separated from the buffer block and the protection switch is off.
